(19) United States
(12) Patent Application Publication
(10) Pub. No.: US 2016/0276969 A1
(43) Pub. Date: Sep. 22, 2016

(54) ELECTRIC MOTOR DRIVER WITH CURRENT SENSOR ERROR CORRECTION

(71) Applicant: DELPHI TECHNOLOGIES, INC., TROY, MI (US)

(72) Inventor: RONALD J. KREFTA, NOBLESVILLE, IN (US)

(21) Appl. No.: 14/664,448

(22) Filed: Mar. 20, 2015

(51) Int. Cl. H02P 21/00; H02P 29/00

(52) U.S. Cl. CPC H02P 21/0035; H02P 29/0088

(57) ABSTRACT

A system configured to operate an electric motor and correct for current measurement errors present in current sensors used by the system includes a plurality of voltage drivers, a plurality of current sensors, and a controller. Each of the plurality of voltage drivers is electrically coupled to each phase of a motor. Each of the plurality of current sensors is each configured to measure current in each phase of the motor. The controller is configured to sample a current-signal from each current sensor, and determine a baseline-offset error of each current sensor based on a plurality of samples of the current-signal from each current sensor while the motor is rotating.

### TECHNICAL FIELD OF INVENTION

This disclosure generally relates to a system configured to operate an electric motor, and more particularly relates to a way to correct for current measurement errors present in current sensors used by the system.

### BACKGROUND OF INVENTION

Many electric motor control systems are equipped with current sensors to monitor the amount of current in each phase of an electric motor so the motor can be run in the most efficient manner and the output torque of the electric motor can be predicted. It is convenient to use Hall effect current sensors; however economical versions are subject to error. The general types of error may be characterized as offset error and gain error, and the gain and offset errors typically vary as a function of temperature, current magnitude, past operating conditions (i.e. hysteresis), external noise, and other factors.

DC offset error in the current sensor may cause a variety of undesirable effects. Among them are the flow of DC current through the phases of the inverter and the motor which leads to additional power loss and heating, torque ripple in the electric machine which results in acoustic noise and mechanical vibration, and incorrect dead time compensation which results in undesirable harmonics in the phase current waveforms.

It has been proposed to determine DC offset error when power is initially applied to the system while the electric motor is not moving and no current is being delivered to the electric motor. However, this technique will not detect errors that change with time or temperature during an operation cycle of the system.

### SUMMARY OF THE INVENTION

In accordance with one embodiment, a system configured to operate an electric motor and correct for current measurement errors present in current sensors used by the system is provided. The system includes a plurality of voltage drivers, a plurality of current sensors, and a controller. Each of the plurality of voltage drivers is electrically coupled to each phase of a motor. Each of the plurality of current sensors is each configured to measure current in each phase of the motor. The controller is configured to sample a current-signal from each current sensor, and determine a baseline-offset error of each current sensor based on a plurality of samples of the current-signal from each current sensor while the motor is rotating.

In another embodiment, a method to operate an electric motor and correct for current measurement errors present in current sensors used in phases of the motor is provided. The method includes the step of providing a plurality of voltage drivers electrically coupled to each phase of a motor. The method also includes the step of providing a plurality of current sensors, each current sensor configured to measure current in each phase of the motor. The method also includes the step of sampling a current-signal from each current sensor. The method also includes the step of determining a baseline-offset error of each current sensor based on a plurality of samples of the current-signal from each current sensor while the motor is rotating.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a schematic diagram of a system configured to operate an electric motor in accordance with one embodiment; and

FIG. 2 is flowchart of a method to correct for current sensor errors in the system of FIG. 1 in accordance with one embodiment.

### DETAILED DESCRIPTION

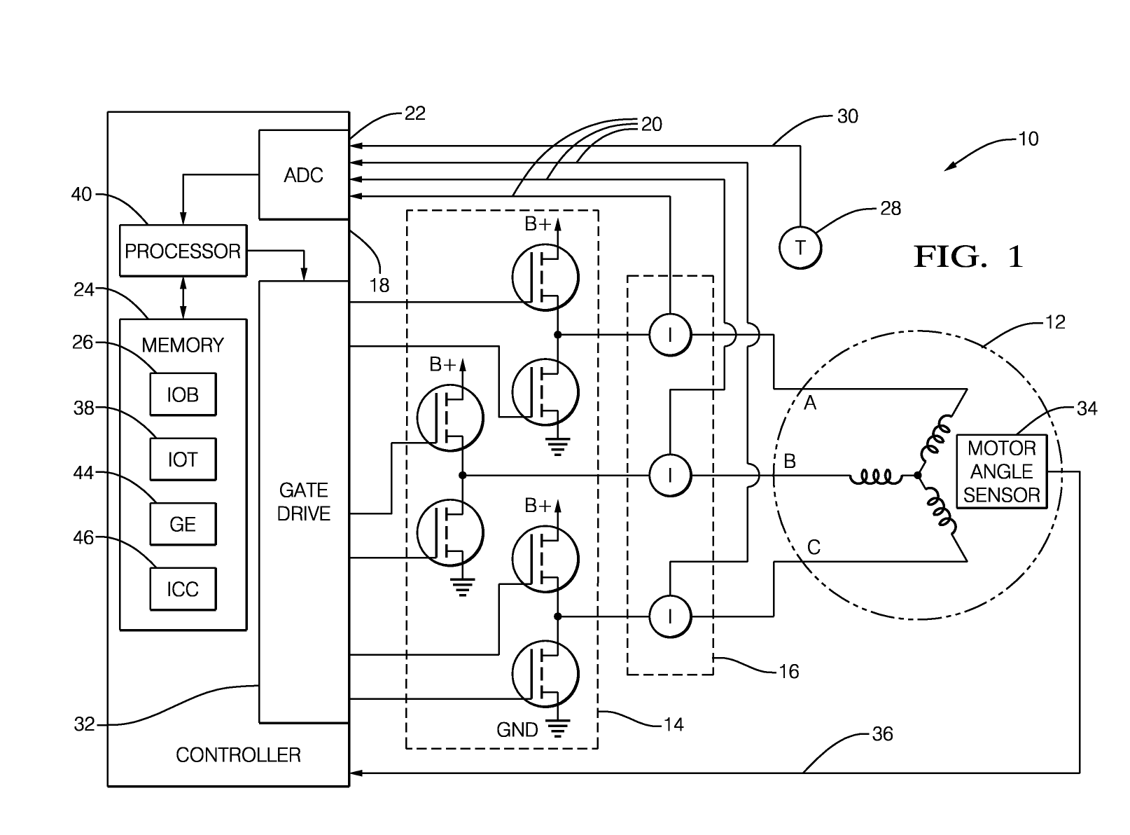

FIG. 1 illustrates a non-limiting example of a system 10 configured to operate an electric motor 12, hereafter referred to as the motor 12. By way of example and not limitation, the system 10 and the motor 12 may be part of a vehicle (not shown), e.g. a hybrid electric vehicle (HEV), where mechanical torque output by the motor 12 is used to propel the vehicle. Those in the art will recognize the that part of the system 10 described herein is sometimes referred to as an inverter which transforms direct current (DC) electric power from a battery pack indicated here by a positive voltage B+ and a reference voltage GND into sinusoidal voltages which are applied to the phases (A, B, C) of the motor 12. It is contemplated that the system 10 described herein could also be used for industrial motor control applications, and could be used to generate trapezoidal voltages instead of sinusoidal voltages. It is further contemplated that the teachings presented herein can be applied to a system that operates or drives electric motors with more or less than three phases.

The system 10 includes a plurality of voltage drivers 14 electrically coupled to each phase of the motor 12. As will be recognized by those in the art, the individual drivers may each be a transistor such as a MOSFET, IGBT, or BJT. Each pair a drivers, i.e. a high-side driver and a low-side driver, may by alternatingly switched on and off at a relatively high frequency, e.g. >1 kHz, to synthesize a sinusoidal signal at each of the phases (A, B, C) of the motor 12.

The system 10 includes a plurality of current sensors 16. In this non-limiting example, each current sensor of the plurality of current sensors 16 is configured to individually measure current in each phase of the motor 12. As will be described in more detail below, the system 10 is advantageously configured to correct for current measurement errors present in each current sensor of the plurality of current sensors 16 used by the system 10. It is also contemplated that the teachings presented herein are applicable to other system configurations where, for example, a single current sensor is used to measure current in the ground path (GND) shared by the plurality of voltage drivers 14.

The system 10 includes a controller 18 configured to sample a current-signal 20 from each current sensor of the plurality of current sensors 16. The controller 18 may include a processor 40 such as a microprocessor or other control circuitry such as analog and/or digital control circuitry including an application specific integrated circuit (ASIC) for processing data as should be evident to those in the art. The controller 18 may include an analog-to-digital converter 22, hereafter the ADC 22, to capture samples of the current-signal 20 and other analog signals present in the system 10. The controller 18 may include memory 24, including non-volatile memory, such as electrically erasable programmable read-only memory (EEPROM) for storing one or more routines, thresholds, and captured data. The one or more routines may be executed by the processor 40 to perform steps to determine, among other things, a baseline-offset error 26, hereafter the IOB 26 of each current sensor of the plurality of current sensors 16. As will be explained in more detail below, the IOB 26 is based on a plurality of samples of the current-signal 20 from each current sensor while the motor is rotating. This feature makes the system 10 distinct from prior systems that only determine a baseline-offset error when initially powered and before the motor is being operated or rotating.

As will become apparent in the description that follows, the IOB 26 is preferably determined for a known temperature, 25° C. for example, so the system 10 is advantageously equipped with a temperature sensor 28 positioned to determine an operating-temperature 30 of the plurality of current sensors 16. The temperature sensor 28 in this non-limiting example is illustrated as being located within the motor 12 only in recognition of the fact that the motor 12 is typically the main source of heat in the system 10. However, if the plurality of current sensors 16 are located remote from the motor 12 on a thermally isolated circuit board assembly (not shown), then it is recognized that the temperature sensor 28 is preferably located proximate to the plurality of current sensors 16, on the same circuit board assembly for example.

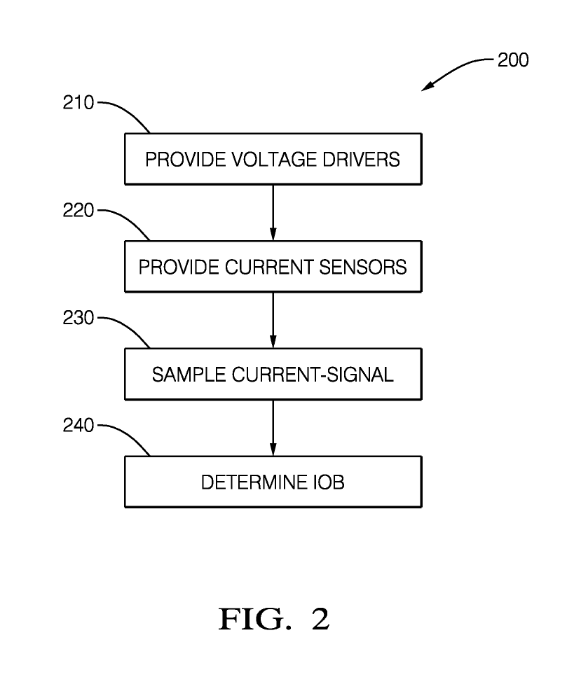

In general, the system 10 is configure to execute a method 200 (FIG. 2) to autocorrect for offset error and gain error, and drift of those errors present in the plurality of current sensors 16. In the equations that follow, abbreviations for known mathematical operations are as follows: ‘sum[ ]’ is used for the summation operation; ‘max[ ]’ is used for the maximum value operation; ‘abs[ ]’ is used for the absolute value operation; and ‘sqrt[ ]’ is used for the square-root operation.

By way of background, errors (E) in Hall-effect current sensors may be defined by Eq. 1 as follows:

E=IOB+IOT*(TO−25)+(GI+GOB+GT*(TO−25))*IP/100 (Eq. 1),

where IOB is the baseline-offset error 26 (the IOB 26) of a current sensor at 25° C. as described above; IOT*(TO−25) is a temperature dependent offset error that is the product of a temperature dependent offset coefficient 38, hereafter the IOT 38, multiplied by the difference between the operating-temperature 30 (TO) and the reference temperature (25° C.) used to determine the IOB 26; GI is a current dependent gain error term; GOB is a baseline-gain error term at 25° C.; and GT*(TO−25) is a temperature dependent gain error term. From this, it can be seen that the correction of the offset and the gain will change as a function of temperature and with current level. Additionally, there may be effects such as magnetic hysteresis which leave residual flux in the sensor and create false offsets at start up.

In order to minimize the influence of applied voltages when trying to determine one or more of the various error terms defined above, the plurality of samples of the current signal 20 are preferably taken while all phases (A, B, C) of the motor 12 are electrically shorted together by the plurality of voltage drivers 14. For example, the gate-driver 32 of the controller 18 may operate all of the high-side drivers to an off-state, and operate all of the low-side drivers to an on-state to short all phases (A, B, C) of the motor 12 together. During this active short circuit operation, for a typical motor, the average DC current from the motor should be equal to zero and the phase current magnitude of the phases should be equal. As such, the IOB 26 of each of the plurality of current sensors 16 is found by averaging the DC current over a period of time.

Since the rotation of the motor 12 is expected to induce current in the coils or phases of the motor 12 while the phases are shorted together, the sampling should be for a relatively long interval of time (i.e. fixed number of current samples) so the average current in each phase is near zero. Preferably, so the expected average current is zero, the angular rotation of the motor 12 should be as close as possible to an integer number of electrical cycles of the motor 12. That is, system 10 may be configured so the plurality of samples of the current signal 20 are taken over an integer number of electrical cycles or electrical rotations of the motor 12, or are taken over an integer number of physical rotations of the motor 12. As used herein, an electrical rotation or electrical cycle of the motor 12 occurs when the pattern of magnetic fields present at each of the coils or phases of the motor 12 is repeated. To this end, the system 10 may include a motor-angle sensor 34 that outputs an angle-signal 36 to the controller 18. The motor-angle sensor 34 may be, for example, an optical encoder that outputs the angle-signal 36 in a digital form. When equipped with the motor-angle sensor 34, the system 10 or the controller 18 can begin gathering samples of the current-signal 20 at, for example, zero electrical degrees and collect data until the last current reading before zero electrical degrees is repeated. During this time, NS samples of the current signal 20 are collected, each sample designated below as I(j). Then the IOB 26 can be calculated using Eq. 2 as follows:

IOB=(1/NS)*sum[I(j)],for j=1 to NS (Eq. 2).

This calculation is typically repeated for each of the current sensors, so each of the plurality of current sensors 16 would have a unique value for the IOB 26 of each current sensor. The IOB 26 can then be used to correct the current measurements for each sensor by Eq. 3 as follows:

IA=IM−IOB (Eq. 3),

where IA is the actual current in phase A of the motor 12; and IM is the measured current reported by the current sensor measuring the phase current in phase A.

A running history of the current offset for each phase may be maintained to discriminate against bad readings or filter the IOB 26 for each current sensor, or to characterize the sensor for predictive performance such as recording offset as a function of board ambient temperature and using this historical information while running to predict the impact of the temperature-offset error, i.e IOT*(TO−25), on the IOB 26. That is, the controller 18 is advantageously configured to determine IOT*(TO−25) of each current sensor of the plurality of current sensors 16 based on the operating-temperature 30.

In order to simplify the determination of the effects of gain in Eq. 1, that is the (GI+GOB+GT*(TO−25))*IP/100 portion of Eq. 1, the gain error 44, hereafter the GE 44 can be determined in several ways. First, it should be recognized that without outside information, it is not possible to know the exact gain error of the sensor. It is possible, however, to balance the sensors to each have the same gain error. While this may still result in an error in the output current vector magnitude, it will eliminate the harmonics which will result in the electric machine due to the unbalance of current regulated phase currents.

If it is assumed that the current sensor gain is random and sensor gains are independent variables, then the average of the sensor gain errors should tend toward zero and provide an estimate of the true gain. That is to say that for a Gaussian distribution of parts of mean of zero, the standard deviation of the average of k parts selected at random will be less than the standard deviation of the total population. Thus, one can both reduce the population variation and eliminate unwanted harmonics by using the average gain as the ideal gain.

Similarly, if the current sensors are not randomly selected from the current sensor population, but assumed to be built together and have near identical gain response, then it is expected the sensors have a gain equal to the average of the available sensors. Any variation from that gain may be due to variation around the local mean which can be reduced when the average is used. Additionally, while using the average gain may induce some current magnitude error, the sensors can be corrected to provide the same gain and hence eliminate real phase current unbalance to the motor and unwanted motor harmonics, audible noise and vibration, and loss as well as compensating for gain variation due to temperature.

As noted earlier, the GE 44 can be determined in a variety of ways, which includes configuring the controller 18 to determine the GE 44 of each current sensor of the plurality of current sensors 16 based on a composite-current value 46, hereafter the ICC 46. That is, the variety of ways to determine the GE 44 generally differs on optional ways to determine the ICC 46 from the samples of the current signal 20.

One option is to determine the ICC 46 based on the maximum value of the absolute value of current, i.e. a maximum-current value, over a period of time to determine the current gain. Fortunately, while in the short circuit mode, the electric machine current magnitude is only very weakly coupled to motor speed and hence can be assumed to be a constant over a period of time consistent with that needed to make appropriate measurements. Thus, the GE 44 for each sensor can be found, from Eq. 4 as follows:

GE=(max[abs[IM−IOB]]−IAVG)/IAVG (Eq. 4),

where IAVG can be found as the average maximum reading of the k current sensors in Eq. 5 as follows:

IAVG=(1/K)*(sum[max[abs[IM(k)−IOB(k)]]]),for k=1 to K (Eq. 5),

where K is the number of current sensors, three in this non-limiting example. The maximum value of current in Eq. 4 can be found by collecting data ideally the same as collected for the DC offset calculation (Eq. 2), where preferable the same data set would be used.

The corrected current can then be found from the measured current and from the DC offset as shown in Eq. 6 as follows:

IA=(IM−IOB)*(1−GE) (Eq. 6).

A second option for evaluating the GE 44 is to consider a root-mean-square (RMS) current value determination of the ICC 46 of each sensor rather than the peak value. The IRMS value may provide a better estimate noting that linearity error may exist which provides a current dependent gain error. The IRMS value of current can be found by collecting data ideally the same as collected for the DC offset calculation, where preferable the same data set would be used. The IRMS current for each phase can then be calculated using known Eq. 7 as follows:

IRMS=sqrt[(1/NS)*(sum[I(j)−IOB])̂2],for j=1 to NS (Eq. 7).

From this, the GE 44 can be found for each phase as shown in Eq. 8 as follows:

GE=(IRMS−IAVG)/IAVG (Eq. 8),

where IAVG is determined using Eq. 9 as follows:

IAVG=(1/K)*(sum[IRMS(k)]),for k=1 to K(e.g. 3) (Eq. 9).

A third option to the GE 44 is to translate the sampled data into the frequency domain through a Discrete Fourier Transform to determine a frequency-transformation value for the fundamental electrical frequency. This will factor out the effects of sensor linearity variation which do not occur at the fundamental frequency and provide an estimate of gain error for the component most import to the motor controller, the electrical fundamental.

As with the sensor offset, a running history of the current gain error for each phase may be maintained to discriminate against bad readings, to filter the gain correction, or to characterize the sensor for predictive performance such as recording gain error as a function of board ambient temperature and using this historical information while running to predict the impact of the temperature dependent current gain term, GT.

FIG. 2 illustrates a non-limiting example of a method 200 to operate an electric motor and correct for current measurement errors present in current sensors used in phases of the motor, said method comprising:

Step 210, PROVIDE VOLTAGE DRIVERS, may include providing a plurality of voltage drivers 14 electrically coupled to each phase of a motor 12.

Step 220, PROVIDE CURRENT SENSORS, may include providing a plurality of current sensors 16, each current sensor configured to measure current in each phase (A, B, C) of the motor 12.

Step 230, SAMPLE CURRENT-SIGNAL, may include sampling a current-signal 20 from each current sensor of the plurality of current sensors 16 by a controller 18.

Step 240, DETERMINE IOB, may include determining a baseline-offset error (the IOB 26) of each current sensor based on a plurality of samples of the current-signal 20 from each current sensor while the motor 12 is rotating.

Accordingly, a system 10, a controller 18 for the system 10 and a method 200 to operate an electric motor and correct for current measurement errors present in current sensors used by the system 10 is provided. By correcting for current measurement errors, acoustic noise and mechanical vibration, and incorrect dead time compensation which results in undesirable harmonics in the phase current waveforms are reduced.

While this invention has been described in terms of the preferred embodiments thereof, it is not intended to be so limited, but rather only to the extent set forth in the claims that follow.

We claim:

1. A system configured to operate an electric motor and correct for current measurement errors present in current sensors used by the system, said system comprising:
a plurality of voltage drivers electrically coupled to each phase of a motor;
a plurality of current sensors, each current sensor configured to measure current in each phase of the motor;
a controller configured to sample a current-signal from each current sensor, and determine a baseline-offset error of each current sensor based on a plurality of samples of the current-signal from each current sensor while the motor is rotating.

2. The system in accordance with claim 1, wherein the plurality of samples are taken while all phases of the motor are electrically shorted together by the plurality of voltage drivers.

3. The system in accordance with claim 1, wherein the plurality of samples are taken over an integer number of electrical rotations of the motor.

4. The system in accordance with claim 1, wherein the plurality of samples are taken over an integer number of physical rotations of the motor.

5. The system in accordance with claim 1, wherein the system includes a temperature sensor positioned to determine an operating-temperature of the plurality of current sensors.

6. The system in accordance with claim 5, wherein the controller is further configured to determine a temperature-offset error of each current sensor based on the operating-temperature.

7. The system in accordance with claim 1, wherein the controller is further configured to determine a gain error of each current sensor based on a composite-current value.

8. The system in accordance with claim 7, wherein the composite-current value is based on one of a maximum-current value, a root-mean-square current value, and a frequency-transformation value.

9. The system in accordance with claim 7, wherein the system includes a temperature sensor positioned to determine an operating-temperature of the plurality of current sensors.

10. A method to operate an electric motor and correct for current measurement errors present in current sensors used in phases of the motor, said method comprising:
providing a plurality of voltage drivers electrically coupled to each phase of a motor;
providing a plurality of current sensors, each current sensor configured to measure current in each phase of the motor;
sampling a current-signal from each current sensor; and
determining a baseline-offset error of each current sensor based on a plurality of samples of the current-signal from each current sensor while the motor is rotating.
